(19) United States
(12) Patent Application Publication
(10) Pub. No.: US 2025/0141756 A1
(43) Pub. Date: May 1, 2025

(54) SECURE, ENCRYPTED, AND ABSTRACTED LOGGING ARCHITECTURE FOR LIFE CYCLE MEASUREMENTS OF INFORMATION HANDLING SYSTEM COMPONENTS

(71) Applicant: DELL PRODUCTS L.P., Round Rock, TX (US)

(72) Inventors: Abeye Teshome, Austin, TX (US); Farzad Khosrowpour, Pflugerville, TX (US); Mitchell Markow, Hutto, TX (US); Ricardo Martinez, Leander, TX (US)

(21) Appl. No.: 18/496,742

(22) Filed: Oct. 27, 2023

(51) Int. Cl. H04L 41/149; H04L 41/14; H04L 41/16

(52) U.S. Cl. CPC H04L 41/149; H04L 41/145; H04L 41/16

(57) ABSTRACT

An information handling system collects telemetry data from a component of an information handling system, and determines the health of the component of the information handling system based on the telemetry data. The system abstracts the health of the component prior to transmitting information on the health of the component to a telemetry framework, and encrypts the telemetry data prior to storing the encrypted telemetry data at a data store.

FIELD OF THE DISCLOSURE

The present disclosure generally relates to information handling systems, and more particularly relates to secure, encrypted, and abstracted logging architecture for life cycle measurements of information handling system components.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system collects telemetry data from a component of an information handling system, and determines the health of the component of the information handling system based on the telemetry data. The system abstracts the health of the component prior to transmitting information on the health of the component to a telemetry framework, and encrypts the telemetry data prior to storing the encrypted telemetry data at a data store.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating an information handling system configured for a secure, encrypted, and abstracted logging architecture for life cycle measurement of its components and/or subcomponents, according to an embodiment of the present disclosure;

FIG. 3 is a block diagram of a data flow for keyboard scan codes, according to an embodiment of the present disclosure;

FIG. 4 is a block diagram of a data flow for battery telemetry data, according to an embodiment of the present disclosure;

FIG. 5 is a block diagram of a data flow for touchpad contact data, according to an embodiment of the present disclosure; and

FIG. 6 shows a flowchart of a method for secure, encrypted, and abstracted logging architecture for life cycle measurements of information handling system components, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

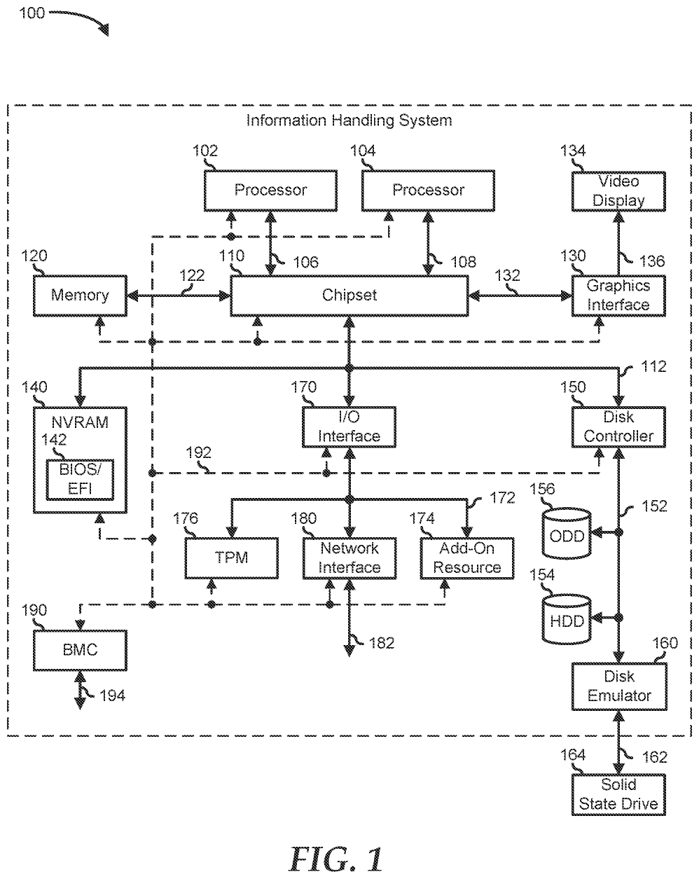

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include a I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Computing device technology is subject to continuous improvement. Customers typically purchase a new or more recent computing device from time to time. A growing number of customers lease computing devices for a period of time. These computing devices may be refurbished and resold after the lease period is over. The resale of computing devices can benefit from more accurate and granular measurements of the health of the computing device. As such, comprehensive testing based on telemetry associated with various components of the computing device, such as its display, storage, keyboard, etc. to certify the health of the components prior to resale may be advantageous. However, protecting the privacy of the customer when logging the telemetry data is generally a challenge. Accordingly, the present disclosure provides an embedded controller-centric architecture that secures, time scrambles, encrypts, and abstracts telemetry data for resale certification and classification of various components of the computing device.

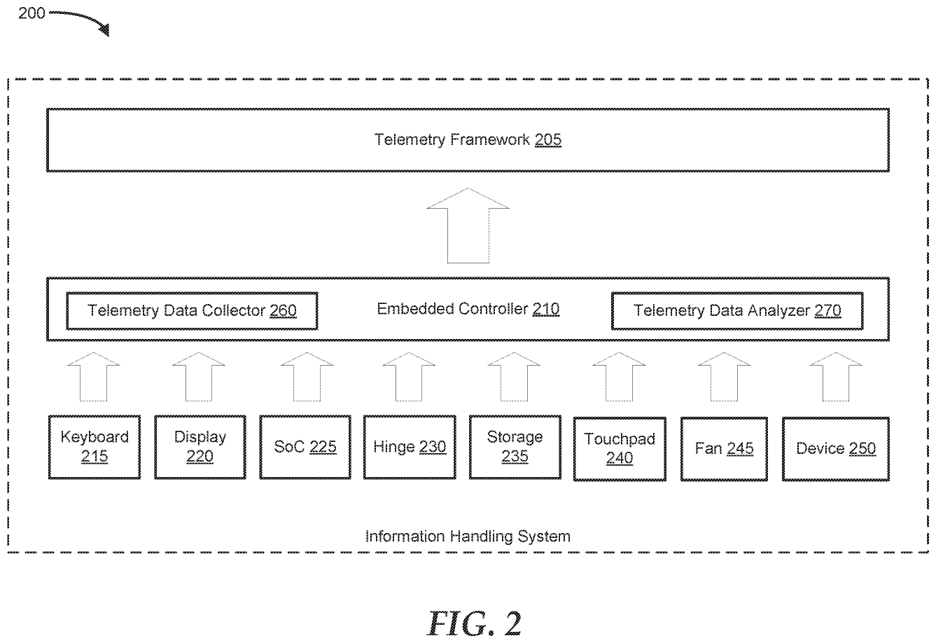

FIG. 2 shows an information handling system 200 configured for a secure, encrypted, and abstracted logging architecture for life cycle measurement of its components and/or subcomponents. Information handling system 200, which is similar to information handling system 100 of FIG. 1, includes a telemetry framework 205, an embedded controller 210, a keyboard 215, a display 220, a system on a chip (SoC) 225, a hinge 230, a storage 235, a touchpad 240, a fan 245, and a device 250. Device 250 may represent other devices, components, or subcomponents of information handling system 200. These and other components or subcomponents may provide telemetry data to embedded controller 210. The components of information handling system 200 may be implemented in hardware, software, firmware, or any combination thereof. Also, the components shown are not drawn to scale and information handling system 200 may include additional or fewer components. In addition, connections between components may be omitted for descriptive clarity.

Telemetry framework 205 may be configured to gather or receive health reports of one or more components and/or subcomponents of information handling system 200. The health report may be used by technicians and/or customers to assess the service life and/or remaining life of the information handling system. The health report may also be used to determine a resale certification, classification, and/or price of the components, subcomponents, and/or the information handling system. For example, an information handling system with an excellent health report may justify a higher resale price than another information handling system with a fair health report. The technicians may also use the health report to fix or replace a component and/or subcomponent with a failing health report.

Embedded controller 210, which is similar to BMC 190 of FIG. 1, may be configured as a hub for securing, encrypting, processing, and abstracting telemetry data from keyboard 215, display 220, SoC 225, hinge 230, storage 235, touchpad 240, fan 245, and device 250. Accordingly, embedded controller 210 may monitor a plurality of parameters indicative of the health and performance of these components and/or subcomponents, such as fan speed, BIOS logs, keyboard scan codes, etc. Accordingly, embedded controller 210 may include a telemetry data collector 260 and a telemetry data analyzer 270 that can collect and analyze telemetry data from various components, such as keyboard 215, display 220, SoC 225, hinge 230, storage 235, touchpad 240, fan 245, and device 250. For example, the telemetry data may include the fan speed of fan 245, the number of operating system crashes if any, brightness of display 220, hinge cycles of hinge 230, battery temperature, etc.

The collection and/or analysis may be performed on a periodic basis, an alert-based basis, or on a manual basis. In addition to the parameters, telemetry data may also include logs, metrics, events, and traces associated with the components and/or subcomponents, such as their operational status. The telemetry data may include information associated with the generation of an alert corresponding to the occurrence of an information handling system issue during a particular lifecycle of the information handling system. As an example, the telemetry data may indicate that the operating temperature of information handling system 200 is approaching its upper limit or manufacturer access codes. In addition, the telemetry data may also include information that fan 245 may be approaching its manufacturer's mean time before failure (MTBF) or other specifications. Further, telemetry data may include information associated with actions of and/or objects interacting with one or more of the components and/or subcomponents. For example, the telemetry data may include scan codes and contact data. The MTBF specification may be used as a baseline for evaluating the health of a component of an information handling system. A consistently high MTBF may indicate that the component is reliable. Accordingly, the health of that component may be rated as new or excellent. A declining MTBF may signify an underlying issue and the health of the component may be rated as fair or poor.

The telemetry data may be stored in embedded controller 210 or at a secure data store of information handling system 200 to prevent unauthorized access. For example, the encrypted telemetry data may only be accessed via a secure out-of-band communication. In another example, embedded controller 210 may be a hardened hardware module that may include a root of trust module configured as a trusted data store. The telemetry data may be encrypted and/or scrambled prior to storage. Encrypting the telemetry data includes using an encryption scheme via a cryptography key to convert the telemetry data into ciphertext. Accordingly, only authorized users can convert the ciphertext back. Scrambling the telemetry data includes rearranging the sequence of the telemetry data based on its timestamps. The telemetry data may be scrambled prior to encryption.

The data store may be a dedicated secure non-volatile storage device for embedded controller 210. The data store may be located locally in embedded controller 210. In another embodiment, the data store may be located remotely from embedded controller 210 or information handling system 200. The remote data store may be located at servers that are dedicated to storing telemetry data from a plurality of information handling systems. Access to the telemetry data stored in the remote data store may be performed via an extension of the embedded controller through the embedded controller's network interface card.

Subsequent to or prior to storage, embedded controller 210 or in particular, telemetry data analyzer 270 may use deep learning techniques to determine the current health of the component and/or subcomponents. For example, embedded controller 210 may use a large language model, a hybrid hidden Markov model, or similar. Each component and/or subcomponent of information handling system 200 can be looked into to determine the best way to abstract the component or subcomponent telemetry data and then characterize such or an analysis thereof in a model. The model can be used in determining the component or the subcomponent's health and/or performance. The model can also be used in filtering out corner cases in the telemetry data prior to encryption, scramble, and/or storage. The analysis may also be based on telemetry data across a plurality of components, subcomponents, and/or information handling systems increasing accuracy in determining their current health.

For example, embedded controller 210 may calculate descriptive statistics, such as mean, median, variance, max, and other values associated with the usage of the component and/or subcomponent. The statistics may be compared to a baseline utilization profile. If the actual usage of the component and/or subcomponent is greater than the baseline, then the usage level may be high. Otherwise, if the actual usage of the component and/or subcomponent is less than the baseline, then the usage level may be low. One of skill in the art may appreciate that these are examples and that other computations, calculations, and/or techniques may be used in determining the health and/or performance of the components and/or subcomponents.

Based on the analysis, telemetry data analyzer 270 may provide an abstracted health report of one or more components and/or subcomponents of information handling system 200. For example, telemetry data analyzer 270 characterizes the health of the components and subcomponents as one of new, excellent, very good, good, fair, and poor. Telemetry data analyzer 270 may also characterize the health of the components and subcomponents on a number scale, such as 1, 2, 3, 4, 5, or the like. Embedded controller 210 may also characterize the level of expected remaining life or life left of the components and/or subcomponents as one of low, medium, or high. Embedded controller 210 may also characterize life usage as one of low usage, medium usage, or high usage. Based on the health of the components and/or subcomponents, embedded controller 210 may characterize overall health, expected remaining life, and/or life usage of information handling system 200. In another embodiment, telemetry data collector 260 and telemetry data analyzer 270 may be included in a life cycle controller included in embedded controller 210.

To protect the privacy of a current owner of information handling system 200, instead of transmitting the telemetry data to telemetry framework 205, embedded controller 210 may transmit the health report. In addition, the health report may also be stored in the embedded controller or a trusted data store. For example, embedded controller 210 may transmit a health report as excellent with its life left as high and overall usage as low for each of the components and/or subcomponents in addition to a general health report of the information handling system. Thus, a potential customer who may look into buying the information handling system may see the health report of one or more components and subcomponents, along with an overall health report for the information handling system.

Those of ordinary skill in the art will appreciate that the configuration, hardware, and/or software components of information handling system 200 depicted in FIG. 2 may vary. For example, the illustrative components within information handling system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

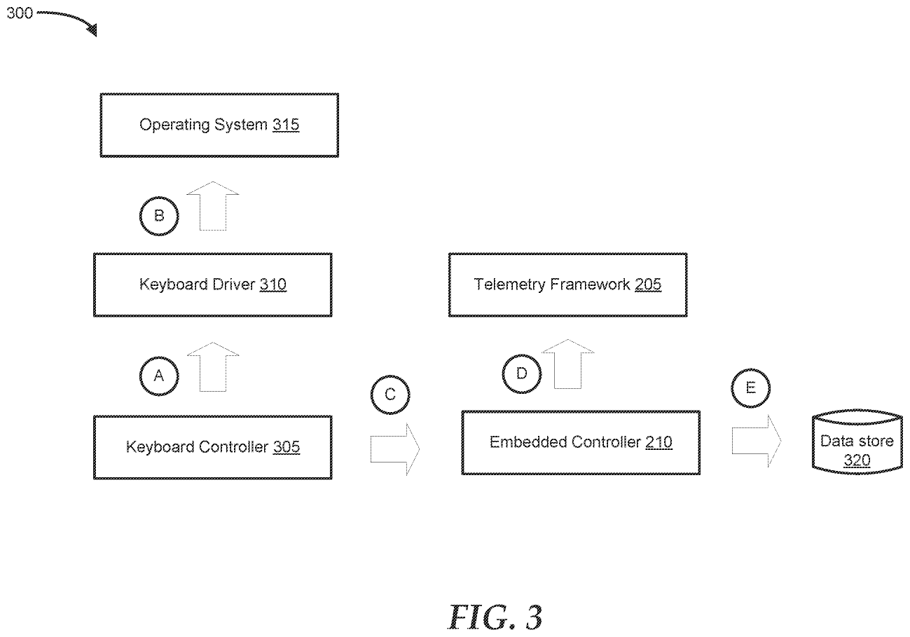

FIG. 3 shows a diagram of a data flow 300 for keyboard scan codes. The diagram of data flow 300 shows the flow of data between a keyboard controller 305, a keyboard driver 310, an operating system 315, embedded controller 210, telemetry framework 205, and a data store 320. Operating system 315 may be one of various types of operating systems, such as Windows®, Linux®, UNIX®, etc. In one embodiment, telemetry data collected by embedded controller 210 may include keyboard keystrokes to determine the health of a keyboard. The keyboard keystrokes can be captured from keyboard controller 305 before the keystrokes are decoded as a letter or a number. In one example, the number of keystrokes can be used to determine a total number of keystrokes per key and determine an expected remaining life of the keyboard based on a manufacturer's mean time between failure (MTBF) or other specifications. The order of the keystrokes can also be scrambled to further abstract the data.

FIG. 3 is annotated with a series of letters A, B, C, D, E, and F. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, keyboard controller 305 may generate a scan code when a key associated with keyboard 215 is actuated, such as when it is pressed, held down, or released. Each scan code may represent a particular keystroke, such as a letter, a number, a symbol, or a special function key on keyboard 215. A special scan code may be generated for a combination of keys, sometimes referred to as hotkeys. The scan code may then be transmitted to keyboard driver 310. At stage B, keyboard driver 310 may transmit the scan code to operating system 315. For example, keyboard driver 310 may broadcast the scan code utilizing standard Windows messages, which can expose the scan code to operating system 315.

At stage C, embedded controller 210 may detect the scan code generated by keyboard controller 305 and collect the scan code. In response to receiving the scan code, embedded controller 210 may encrypt and/or scramble the scan code prior to storing it at data store 320. Subsequent to or prior to the storage, embedded controller 210 may also analyze the scan code in accordance with a set of scan codes along with other telemetry data, such as MTBF data to characterize the health of the keyboard.

During the analysis, a model may be used to filter corner cases in the telemetry data, such as the scan codes collected. For example, a keystroke and a stuck key are not the same thing. A stuck key may occur due to a liquid spill. The stuck key may also occur when the customer has held down a key for long, such as when the customer falls asleep on the keyboard. Accordingly, the stuck key may generate a different count and behavior. Thus, when analyzing the scan code, embedded controller 210 may use a model that may detect the stuck key and filter it out before it gets incorporated into overall statistics. Embedded controller 210 may also account for different key functions, keyboard layout, and usage based on different languages and the purpose of the keyboard. At stage D, embedded controller 210 may transmit an abstraction of the scan code to telemetry framework 205. At stage E, embedded controller 210 may also store the scan code and/or the abstraction of the keyboard health in data store 320. Data store 320 may be a secure non-volatile storage device that may be located locally or remotely from the information handling system. Data store 320 may also be a trusted data store that is included in embedded controller 210. In one embodiment, data store 320 may be secured by a TPM. Prior to storing the scan code, embedded controller 210 may also scramble or encrypt the scan code.

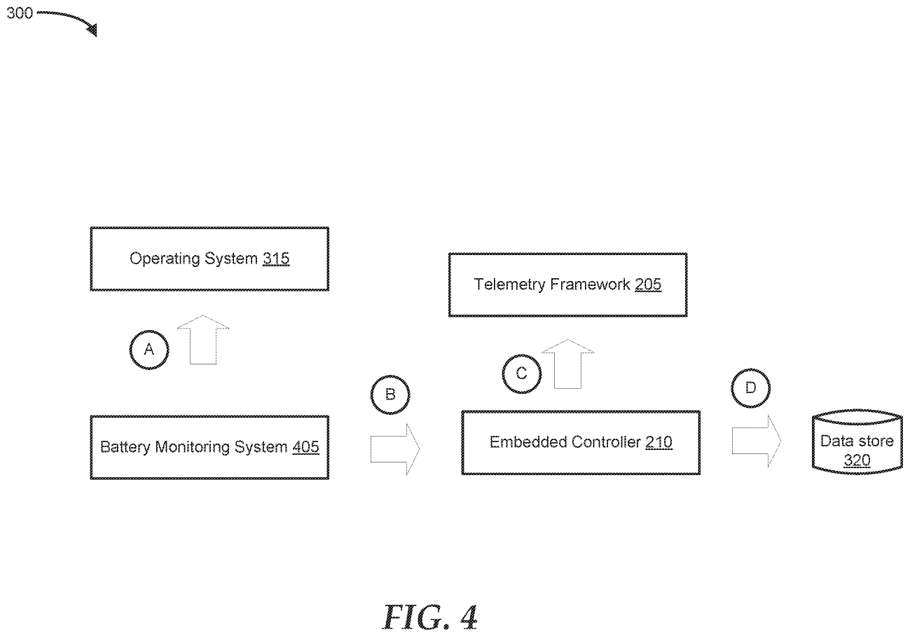

FIG. 4 shows a diagram of a data flow 300 for battery telemetry data. The diagram of data flow 300 shows the flow of data between a battery monitoring system 405, operating system 315, embedded controller 210, telemetry framework 205, and data store 320. FIG. 3 is annotated with a series of letters A, B, C, and D. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, battery monitoring system 405 may transmit telemetry data associated with a battery of the information handling system to operating system 315. Battery monitoring system 405 may periodically probe the battery for various information. For example, the battery monitoring system may track and log battery status and events, such as via battery manufacturer access codes. The 16-bit manufacturer access codes provide the system with detailed information on the inner workings of the battery and in an event of failure, a means by which a failure mode can be determined. At stage B, battery monitoring system 405 may also transmit the telemetry data to embedded controller 210. Embedded controller 210 may process the telemetry data to determine the health, usage level, and remaining life of the battery. At stage C, embedded controller 210 may transmit information regarding the health, usage level, and the remaining life of the battery to telemetry framework 205. At stage D, embedded controller 210 may store the telemetry data in data store 320. In addition, embedded controller 210 may scramble and/or encrypt the telemetry data prior to storage.

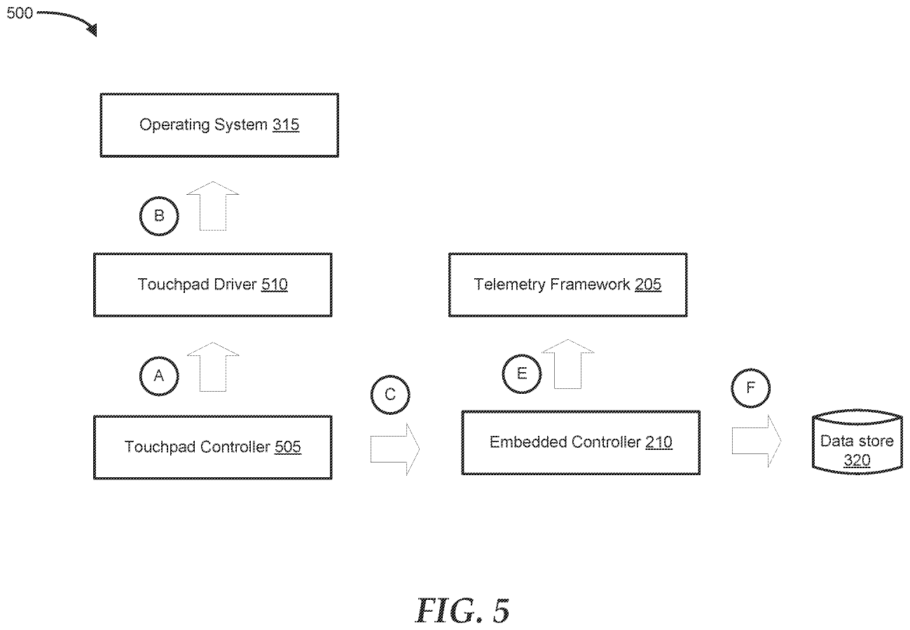

FIG. 5 shows a diagram of a data flow 500 for touchpad contact data. The diagram of data flow 500 shows the flow of data between a touchpad controller 505, a touchpad driver 510, operating system 315, embedded controller 210, telemetry framework 205, and data store 320. In one embodiment, telemetry data collected by embedded controller 210 may include touchpad contact data to determine the health of a touchpad.

FIG. 5 is annotated with a series of letters A, B, C, D, E, and F. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, touchpad controller 505 may generate contact data when contact is detected on the touchpad. The contact data may include contact identifier, contact coordinates, scan time, etc. At stage B, touchpad driver 510 may transmit the contact data to operating system 315. For example, touchpad driver 510 may broadcast the contact data utilizing standard Windows messages, which can expose the contact data to operating system 315.

At stage C, embedded controller 210 may detect the contact data generated by touchpad controller 505 and collect the contact data. In response to receiving the contact data, embedded controller 210 may encrypt and/or scramble the contact data prior to storing it at data store 320. Subsequent to or prior to the storage, embedded controller 210 may also analyze the contact data in accordance with a set of contact data along with other telemetry data, such as MTBF data to characterize the health of the touchpad.

At stage D, embedded controller 210 may transmit an abstraction of the contact data to telemetry framework 205. At stage E, embedded controller 210 may also store the contact data and/or the abstraction of the keyboard health in data store 320. Prior to storing the contact data, embedded controller 210 may also scramble or encrypt the contact data.

One of skill in the art will appreciate that the data flow diagrams shown herein explain an example of data flows in collecting telemetry data from the components and/or subcomponents of the information handling system. The telemetry data collection may be performed in other ways aside from the ones shown herein.

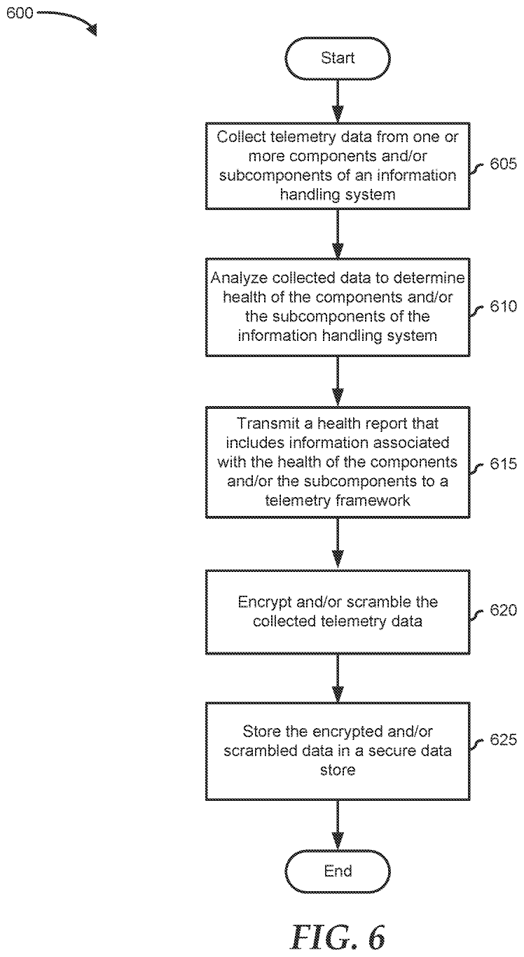

FIG. 6 shows a flowchart of a method 600 for secure, encrypted, and abstracted logging architecture for life cycle measurements of information handling system components. Method 600 may be performed by one or more components of information handling system 200 of FIG. 2. However, while embodiments of the present disclosure are described in terms of information handling system 200 of FIG. 2, it should be recognized that other systems may be utilized to perform the described method. One of skill in the art will appreciate that this flowchart explains a typical example, which can be extended to advanced applications or services in practice.

Method 600 typically starts at block 605 where an embedded controller may collect telemetry data from one or more components and/or subcomponents of an information handling system as part of conducting life cycle measurements of the information handling system's components and/or subcomponents. This allows the embedded controller to monitor the health of the components and/or subcomponents. The method proceeds to block 610 where the embedded controller may analyze the collected telemetry data to determine the health of the components and/or the subcomponents. The method proceeds to block 615 where the embedded controller may transmit a health report that includes information regarding the health of the components and/or subcomponents. The health report may also include the overall health of the information handling system based on the health of its components and/or subcomponents. The health report may include abstracted information associated with the health of the components and subcomponents instead of results associated with computations based on the telemetry data. The method may proceed to block 620 where the embedded controller may encrypt and/or scramble the collected telemetry data prior to storage. The method may proceed to block 625 where the embedded controller may store the encrypted and/or scrambled telemetry data at a secure data store. Afterwards, the method ends.

Although FIG. 6 shows example blocks of method 600 in some implementations, method 600 may include additional blocks, fewer blocks, different blocks, or differently arranged blocks than those depicted in FIG. 6. Those skilled in the art will understand that the principles presented herein may be implemented in any suitably arranged processing system. Additionally, or alternatively, two or more of the blocks of method 600 may be performed in parallel. For example, blocks 615 and 620 of method 600 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
collecting, by a processor, telemetry data from a component of an information handling system;
determining health of the component of the information handling system based on the telemetry data;
abstracting the health of the component prior to transmitting information on the health of the component to a telemetry framework; and
encrypting the telemetry data prior to storing the encrypted telemetry data in a data store.

2. The method of claim 1, further comprising scrambling the telemetry data by rearranging a sequence of the telemetry data.

3. The method of claim 1, wherein the determining the health of the component includes determining an expected remaining life of the component.

4. The method of claim 1, wherein the determining the health of the component includes determining usage of the component.

5. The method of claim 1, wherein the determining of the health of the component is performed by using a deep learning technique.

6. The method of claim 1, wherein the determining the health of the component includes using telemetry data from another component.

7. The method of claim 1, wherein a model is used to filter a corner case in the telemetry data.

8. An information handling system, comprising:
a processor; and
a memory storing instructions that when executed cause the processor to perform operations including:
collecting telemetry data from a component of an information handling system;
determining health of the component of the information handling system based on the telemetry data;
abstracting the health of the component prior to transmitting information on the health of the component to a telemetry framework; and
encrypting the telemetry data prior to storing the encrypted telemetry data at a data store.

9. The information handling system of claim 8, wherein the operations further comprise scrambling the telemetry data by rearranging a sequence of the telemetry data.

10. The information handling system of claim 8, wherein the determining the health of the component includes determining an expected remaining life of the component.

11. The information handling system of claim 8, wherein the determining the health of the component includes determining usage of the component.

12. The information handling system of claim 8, wherein the determining of the health of the component is performed by using a deep learning technique.

13. The information handling system of claim 8, wherein a model is used to filter a corner case in the telemetry data.

14. A non-transitory computer-readable medium to store instructions that are executable to perform operations comprising:
collecting telemetry data from a component of an information handling system;
determining health of the component of the information handling system based on the telemetry data;
abstracting the health of the component prior to transmitting information on the health of the component to a telemetry framework; and
encrypting the telemetry data prior to storing the encrypted telemetry data at a data store.

15. The non-transitory computer-readable medium of claim 14, wherein the operations further comprise scrambling the telemetry data by rearranging a timestamps.

16. The non-transitory computer-readable medium of claim 14, wherein the determining the health of the component includes determining an expected remaining life of the component.

17. The non-transitory computer-readable medium of claim 14, wherein the determining the health of the component includes determining usage of the component.

18. The non-transitory computer-readable medium of claim 14, wherein the determining the health of the component is performed by using a deep learning technique.

19. The non-transitory computer-readable medium of claim 14, wherein the determining the health of the component includes using telemetry data from another component.

20. The non-transitory computer-readable medium of claim 14, wherein a model is used to filter a corner case in the telemetry data.
